(19) United States
(12) Patent Application Publication
(10) Pub. No.: US 2011/0302329 A1
(43) Pub. Date: Dec. 8, 2011

(54) Embedded Programmable Module for Host Controller Configurability

(76) Inventors: Asad Azam, Folsom, CA (US); Dhinesh A/L Sasidaran, Seremban (MY)

(21) Appl. No.: 12/793,535

(22) Filed: Jun. 3, 2010

(51) Int. Cl. G06F 12/02; G06F 13/20; G06F 3/00

(52) U.S. Cl. 710/14; 711/103; 710/16; 710/313; 711/E12.008

(57) ABSTRACT

An apparatus comprises a programmable logic device coupled to an interconnect is presented. In one embodiment, the apparatus includes a non-volatile memory to store code for programming the programmable logic device. A controller will program the programmable logic device such that the interconnect is operable in a number of modes associated with a number of input/output devices.

### FIELD OF THE INVENTION

Embodiments of the invention relate to input/output interfaces of computer systems.

### BACKGROUND OF THE INVENTION

An input/output controller hub, for example, a platform controller hub (PCH), supports a number of high speed peripheral devices of various I/O protocols and standards. In order to provide Original Equipment Manufacturers (OEMs) the flexibility, the controller hub may include given host controller(s) to support peripheral device(s) in conjunction with the respective protocol(s).

In general, different host controllers are required to support different types of devices that will be connected an input/output port. In view of cost and space constraints, the number of devices supported by the controller hub is therefore limited. For example, if a controller hub supports a maximum of eight PCIe devices, the OEMs will also be limited to a design consumer models that use no more than eight PCIe devices.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a platform controller hub in accordance with one embodiment of the invention.

FIG. 2 is a flow diagram of one embodiment of a process to configure a programmable interconnect.

FIG. 3 illustrates a computer system for use with one embodiment of the present invention.

FIG. 4 illustrates a point-to-point computer system for use with one embodiment of the invention.

### DETAILED DESCRIPTION OF THE INVENTION

An apparatus comprises a programmable logic device coupled to an interconnect is presented. In one embodiment, the apparatus includes a non-volatile memory to store code for programming the programmable logic device. A controller will program the programmable logic device such that the programmable logic device in conjunction with the interconnect is operable in a number of modes associated with a number of input/output devices.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

The method and apparatus described herein are for generic input/output interconnects. Specifically, the input/output interconnects are primarily discussed in reference to multi-core processor computer systems. However, the input/output interconnects are not so limited, as they may be implemented on or in association with any integrated circuit device or system, such as cell phones, personal digital assistants, embedded controllers, mobile platforms, desktop platforms, and server platforms, as well as in conjunction with other resources, such as hardware/software threads.

### Overview

An apparatus comprises a programmable logic device coupled to a common interconnect is presented. In one embodiment, the apparatus includes a non-volatile memory to store code for programming the programmable logic device. A controller will program the programmable logic device such that the common interconnect (in conjunction with the programmable device) is operable in a number of modes associated with a number of input/output devices. The common interconnect will be described in further detail below with additional references to the remaining figures.

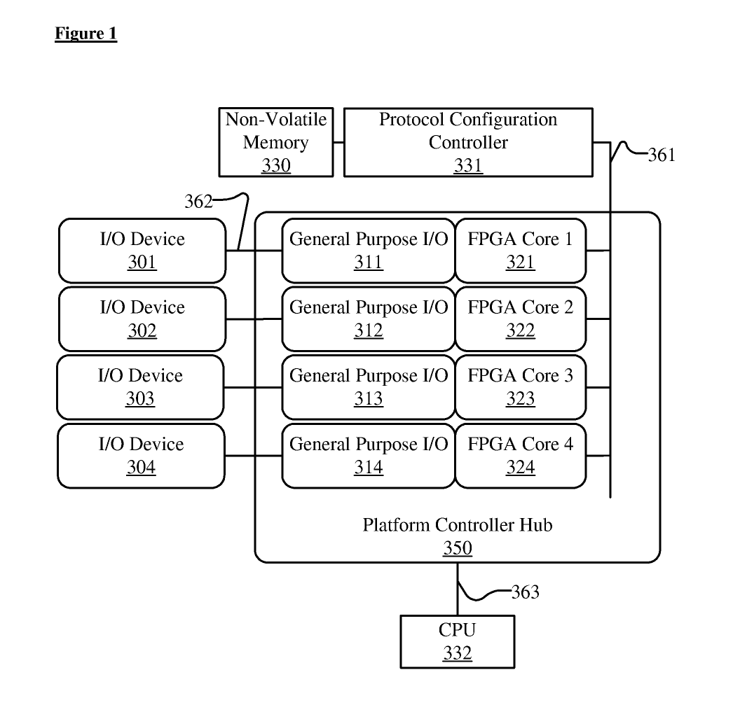

FIG. 1 is a block diagram of a platform controller hub in accordance with one embodiment of the invention. Many related components such as buses and peripherals have not been shown to avoid obscuring the invention. Referring to FIG. 1, platform controller hub 350 comprises interconnects 311-314 and programmable logic devices 321-324. In one embodiment, programmable logic devices 321-324 are coupled to protocol configuration controller 311 via one or more interfaces 361. Protocol configuration controller 331 is coupled to non-volatile memory 330. In one embodiment, processing unit 332 is coupled to platform controller hub 350 via host bus 363. In one embodiment, I/O devices 301-304 are coupled to interconnects 311-314. For example, I/O device 301 is coupled to interconnect 311 via interface 362. In one embodiment, interfaces 361 include a BIOS update interface bus and a FPGA configuration interface bus.

In one embodiment, programmable logic device 321 is a field programmable gate array (FPGA) or a complex programmable logic device (CPLD). In one embodiment, programmable logic devices 321-324 are proprietary embedded FPGA cores. In one embodiment, programmable logic devices 321-324 are coupled to interconnects 311-314. A generic host controller includes a programmable logic device and an interconnect, for example, programmable logic device 321 and interconnect 311.

In one embodiment, protocol configuration controller 331 (controller 331) is operable to program programmable logic device 321 such that interconnect 311 is operable in different modes associated with different I/O devices. In one embodiment, non-volatile memory 330 stores code to program/configure programmable logic devices 321-324. In one embodiment, the code is compiled and translated FPGA programming code for various types of host controllers. The FPGA programming code is a result by compiling/translating RTL code which is written to represent one or more host controllers. In one embodiment, the code in non-volatile memory 330 is encrypted. In one embodiment, the various I/O devices include devices operating in conjunction with PCIe (Peripheral Component Interconnect Express), SATA (Serial Advanced Technology Attachment) device, and USB (Universal Serial Bus).

In one embodiment, controller 331 is a microprocessor or a dedicated microcontroller. Controller 331 retrieves code from non-volatile memory 330 and configures programmable logic devices 321-324 using the code so that interconnects 311-314 interconnects operate as host controllers corresponding to I/O devices 301-304.

In one embodiment, controller 331 detects the type of an I/O device in response to insertion of the I/O device, a system event, a BIOS event, or any combination thereof.

In one embodiment, controller 331 decrypts the code from non-volatile memory 330 if the code is encrypted. Controller 331 triggers an error signal if an I/O device is not supported. Controller 331 registers I/O device when the I/O device is ready for use. In one embodiment, controller 331 detects removal of an I/O device from interconnect 311 and the insertion of a second I/O device of a different type to interconnect 311. Controller 331 retrieves the code associated with the second I/O device. Controller 331 configures programmable logic device 321 such that interconnect 311 is operable to communicate with the second I/O device.

In one embodiment, controller 331 sends an interrupt (e.g., Message Signaled Interrupts) to indicate a device connection. In one embodiment, platform controller hub 350 asserts that the I/O device is ready and a corresponding software stack is loaded to enable the I/O device for use in different applications. In one embodiment, a generic host controller driver software layer discovers the attached device and completes any pending configurations. The generic host controller driver software layer uses a software stack associated with the attached device.

In one embodiment, interconnect 311 is a common input/output port (generic) which conforms to a common electrical/connector specification. In one embodiment, interconnect 311 is a generic device interface which is able to sustain multiple I/O protocols over a common physical connector and electrical protocol. Interconnect 311 is operable to detect an attached device by using one or more detection methods such as, for example, wavelength matching and interlock switches.

In one embodiment, interconnect 311 is a converged I/O. A converged I/O is a technology to enable OEMs to have standard connectors on the electronic boards for different types of high speed peripheral devices. In one embodiment, interconnect 311 is configurable by programmable logic device 321 rather than statically assigned to the protocol supported by an attached host controller. A converged I/O is an interconnect architecture that implements a generalized transport infrastructure to provide the ability to simultaneously carry multiple I/O protocols over a common set of wires. Converged I/O may replace multiple connector types found on computers (e.g., a universal serial bus (USB) interface, an IEEE 1394 interface, Ethernet, eSATA, VGA, DVI, DisplayPort, and HDMI) with a single connector type.

In one embodiment, interconnect 311 is configurable to operate in conjunction with different I/O devices without having different host controllers on the electronic board.

In one embodiment, I/O device 301 is an input/output device to communicate with processing unit 332. Examples of I/O devices includes input/output devices, bidirectional input/output devices, input devices, output devices, and other peripheral devices which capable of communicating with a computer system.

In one embodiment, I/O device 301 can be coupled to any of the interconnect (interconnects 311-314) such that I/O device 301 can be located at different locations on a electronic board. OEMs can dynamically configure PCH 350 to cater for different product models based on different board layouts.

In one embodiment, if interconnect 311 (converged I/O port) is not statically connected to a device, I/O device 301 is an I/O device attached by a user. Controller 331, upon detection of the type I/O device 301, receives an interrupt. Controller 331 fetches the corresponding FPGA programming code from non-volatile memory 330. For example, if a SATA device is plugged in to interconnect 311, the programmable logic device 321 (coupled to interconnect 311) is programmed into the functionality of a SATA host controller. If the SATA device is removed and a USB device is attached on the same interconnect, then programmable logic device 321 is dynamically reprogrammed into a USB host controller.

In one embodiment, OEMs have the flexibility to choose from one of interconnects 311-314 (at different locations on an electronic board) to be used for a platform device (which is not physically visible to end-users). The placement of the device is not restricted to a particular port. For example, OEMs can choose to configure interconnects into different combinations of SATA host controllers and PCIe host controllers (e.g., 2 PCIe and 2 SATA controllers, 4 PCIe controllers, 4 SATA controllers, or 1 PCIE and 3 SATA controllers).

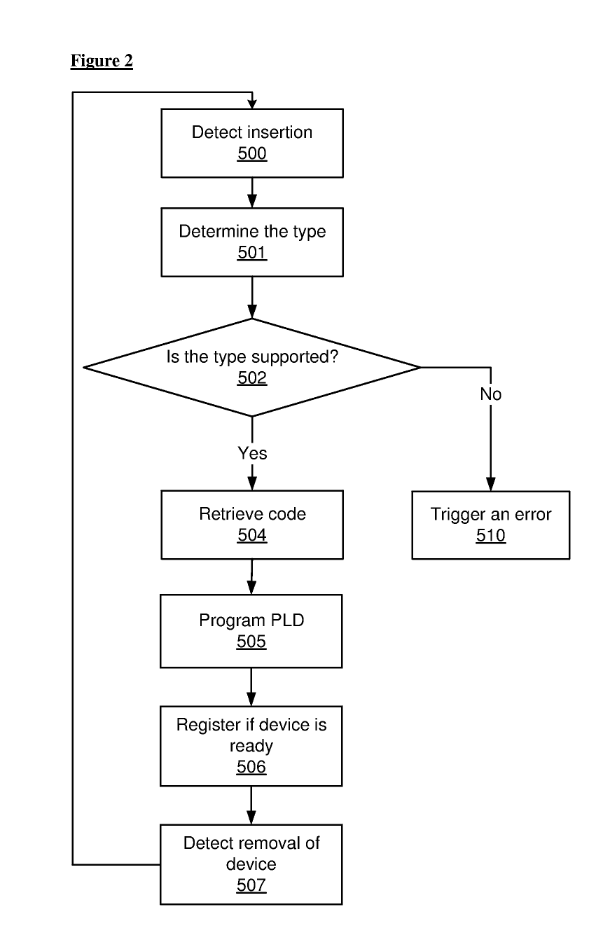

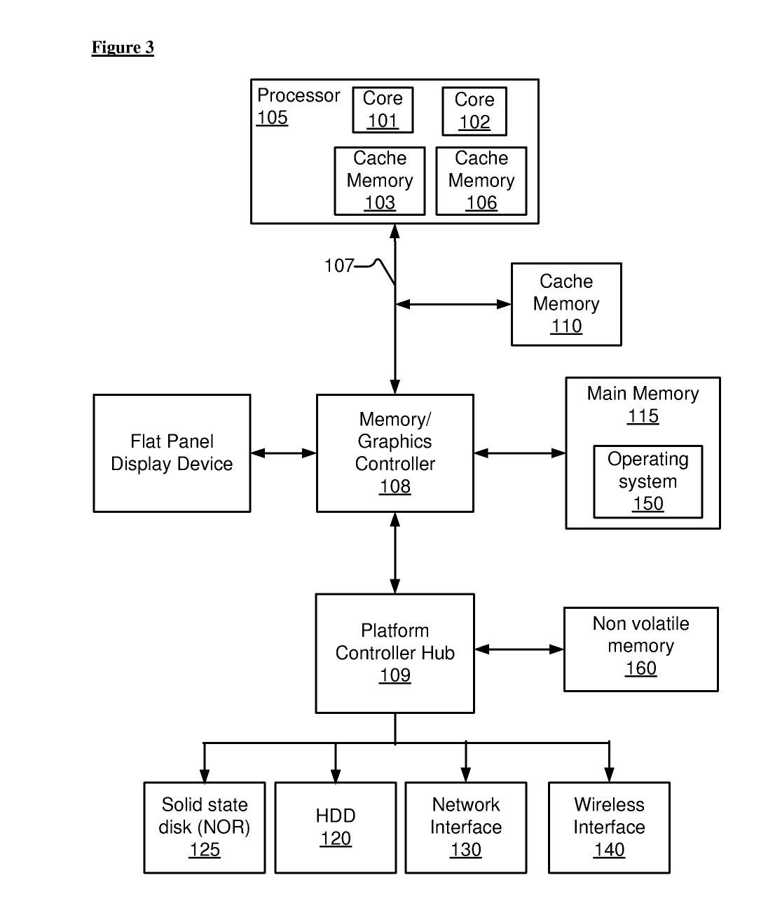

FIG. 2 is a flow diagram of one embodiment of a process to configure a programmable interconnect. The process is performed by processing logic that may comprise hardware (circuitry, dedicated logic, etc.), software (such as one that is run on a general purpose computer system or a dedicated machine), or a combination of both. In one embodiment, the process is performed in conjunction with an apparatus (e.g., platform controller hub 350 with respect to FIG. 1). In one embodiment, the process is performed by a computer system with respect to FIG. 3.

Referring to FIG. 2, in one embodiment, processing logic begin by detecting insertion of an I/O device to an interconnect (process block 500). In one embodiment, the interconnect is a converged I/O. In one embodiment, processing logic detects the electrical idle status of the interconnect to determine whether or not the I/O device is attached. In one embodiment, processing logic receives a system event, for example, a BIOS boot event, to configure an interconnect.

In one embodiment, processing logic determines the type of the I/O device (process block 501). In other embodiment, processing logic determines the type of the I/O device based on the content of a system event message.

In one embodiment, processing logic determines whether the I/O device is supported (process block 502). Processing logic triggers an error signal if the I/O device is not supported (process block 510). Otherwise, processing logic retrieves code to program the interconnect such that the interconnect operates in conjunction with the protocol of the I/O device (process block 504). In one embodiment, the code is a compiled result of RTL code written to emulate a host controller of an I/O protocol/standard.

In one embodiment, processing logic decrypts the code and program a programmable logic device attached to the interconnect (process block 505). The programmable logic device is a FPGA or a CPLD. Processing logic registers the I/O device when the device is ready (process block 506).

In one embodiment, processing logic detects removal of the I/O device from the interconnect (process block 507). Processing logic continues to detect insertion of a second I/O device to the interconnect. Processing logic retrieves code to program the interconnect to operate in conjunction with a different protocol according to the type of the second I/O device.

FIG. 3 is a block diagram illustrating a computer system in accordance with one embodiment of the present invention. In one embodiment, the computer system includes processor 105, memory/graphics controller 108, platform controller hub 109, main memory 115, and non-volatile memory 160. In one embodiment, processor 105 accesses data from level 1 (L1) cache memory 106, level 2 (L2) cache memory 110, and main memory 115. In one embodiment, processor 105 is coupled to memory/graphics controller 108. Memory/graphics controller 108 is coupled to platform controller hub 109, which in turn, coupled to non-volatile memory 160, solid state disk 125, hard disk drive 120, network interface 130, and wireless interface 140. In one embodiment, main memory 115 loads operating system 150.

In one embodiment, processor 105 comprises core 101, core 102, cache memory 103, and cache memory 106. In one embodiment, cache memory 103 is a private cache of core 101, whereas cache memory 106 is a private cache of core 102.

In one embodiment, main memory 115 may be implemented in various memory sources, such as dynamic random-access memory (DRAM), hard disk drive (HDD) 120, solid state disk 125 based on NVRAM technology, or a memory source located remotely from a computer system via network interface 130 or via wireless interface 140 containing various storage devices and technologies. The cache memory may be located either within the processor or in close proximity to the processor, such as on the processor's local bus 107.

In one embodiment, non-volatile memory 160 is a system read only memory (ROM) or a non-volatile memory device. In one embodiment, non-volatile memory 160 contains compiled code to program one or more host controllers in platform controller hub 109.

In one embodiment, platform controller hub 109 includes one or more I/O host controllers that control one or more I/O interconnects (not shown). In one embodiment, platform controller hub 109 is coupled to processor 105 with a single link (i.e., interconnect or bus). In one embodiment, this coupling may be accomplished over a series of links. In one embodiment, processor 105 is coupled over a first link (e.g., local bus 107) to memory/graphics controller 108 (where the memory complex interfaces with a memory subsystem), and memory/graphics controller 108 is coupled to platform controller hub 109 over a second link. In one embodiment, I/O interconnects are a combination of point-to-point interconnects and buses.

In many embodiments, at least one processor 105 is present. In one embodiment, multiple processor cores are present in the system (cores 101-102). In one embodiment, multiple processors, each with single or multi-cores are present in the system (not shown). In embodiments where there are multiple cores and/or multiple processors in the system, a single master core is designated to perform boot and other such system handling processes in the system.

In one embodiment, processor 105, cache memory 106, memory/graphics controller 108, and platform controller hub 109 are in a same package. In one embodiment, processor 105, cache memory 106, memory/graphics controller 108, and platform controller hub 109 are on a same substrate. In one embodiment, processor 105, cache memory 106, memory/graphics controller 108, and platform controller hub 109 are on a same substrate or in a same package.

Other embodiments of the invention, however, may exist in other circuits, logic units, or devices in conjunction with the system of FIG. 3. Furthermore, other embodiments of the invention may be distributed throughout several circuits, logic units, or devices illustrated in FIG. 3.

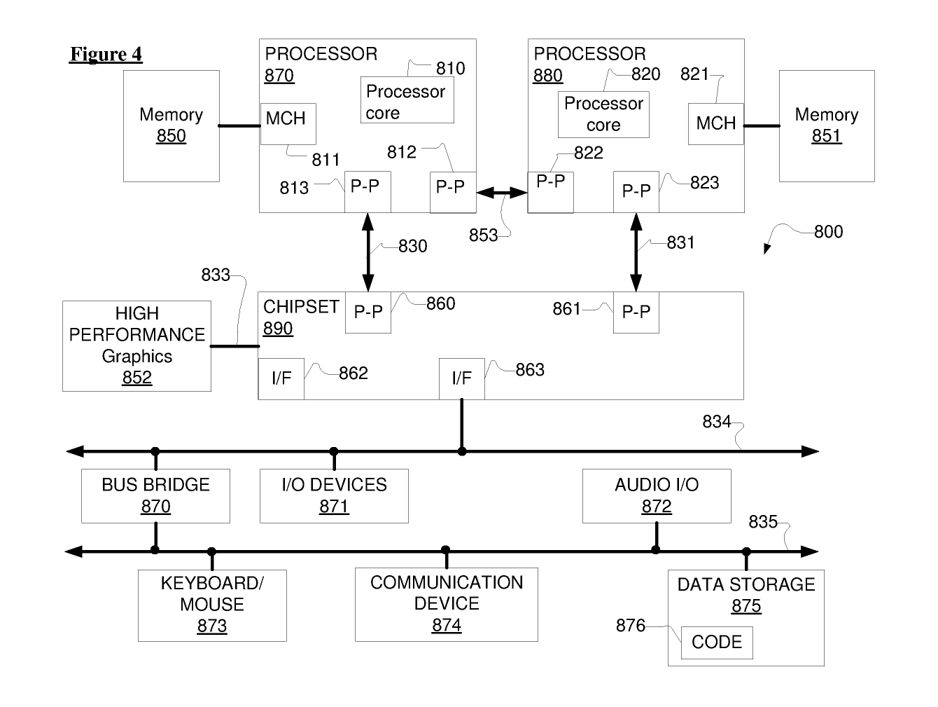

FIG. 4 illustrates a point-to-point computer system for use with one embodiment of the invention.

FIG. 4, for example, illustrates a computer system that is arranged in a point-to-point (PtP) configuration. In particular, FIG. 4 shows a system where processors, memory, and input/output devices are interconnected by a number of point-to-point interfaces.

The system of FIG. 4 may also include several processors, of which only two, processors 870, 880 are shown for clarity. Processors 870, 880 may each include a local memory controller hub (MCH) 811, 821 to connect with memory 850, 851. Processors 870, 880 may exchange data via a point-to-point (PtP) interface 853 using PtP interface circuits 812, 822. Processors 870, 880 may each exchange data with a chipset 890 via individual PtP interfaces 830, 831 using point to point interface circuits 813, 823, 860, 861. Chipset 890 may also exchange data with a high-performance graphics circuit 852 via a high-performance graphics interface 862. Embodiments of the invention may be coupled to computer bus (834 or 835), or within chipset 890, or coupled to data storage 875, or coupled to memory 850 of FIG. 4.

Other embodiments of the invention, however, may exist in other circuits, logic units, or devices within the system of FIG. 4. Furthermore, in other embodiments of the invention may be distributed throughout several circuits, logic units, or devices illustrated in FIG. 4.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chipset components, programmable logic arrays (PLA), memory chips, network chips, or the like. Moreover, it should be appreciated that exemplary sizes/models/values/ranges may have been given, although embodiments of the present invention are not limited to the same. As manufacturing techniques (e.g., photolithography) mature over time, it is expected that devices of smaller size could be manufactured.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. An apparatus comprising:
a programmable logic device coupled to a first interconnect;
a non-volatile memory to store code to program the programmable logic device; and
a controller operable to program the programmable logic device such that the first interconnect is operable in a plurality of modes associated with a plurality of input/output devices.

2. The apparatus of claim 1, wherein the controller is operable to detect a type of a first input/output device in response to insertion of the first input/output device or a system event.

3. The apparatus of claim 2, wherein the controller is operable to
retrieve the code associated with the type of the first input/output device;
program the programmable logic device such that the first interconnect is operable to communicate with the first input/output device;
detect removal of the first input/output device from the first interconnect;
detect insertion of a second input/output device to the first interconnect;
retrieve the code associated with the second input/output device; and
program the programmable logic device such that the first interconnect is operable to communicate with the second input/output device.

4. The apparatus of claim 1, wherein the programmable logic device includes a field-programmable gate array (FPGA) or a complex programmable logic device (CPLD).

5. The apparatus of claim 1, wherein the first interconnect is a converged I/O interconnect.

6. The apparatus of claim 1, wherein the controller is operable to
decrypt the code from the non-volatile memory if the code is encrypted;
detect insertion of a first input/output device or a system event;
trigger an error signal if the first input/output device is not supported; and
register the first input/output device if the first input/output device is ready.

7. The apparatus of claim 1, wherein the first interconnect is operable in one of the plurality of modes associated with the plurality of input/output devices without a plurality of host controllers on an electronic board.

8. The apparatus of claim 1, further comprising a second interconnect programmable to operate in the plurality of modes such that an input/output device is capable of coupled with either the first interconnect or the second interconnect at different locations on an electronic board.

9. The apparatus of claim 1, wherein the plurality of input/output device comprising two or more different input/output devices operable in conjunction with PCIe (Peripheral Component Interconnect Express), SATA (Serial Advanced Technology Attachment) device, and USB (Universal Serial Bus).

10. A method comprising:
determining a first type of a first input/output device coupled to an interconnect;
retrieving code associated with the first type; and
programming a programmable logic device such that the interconnect is operable to communicate with the first input/output device.

11. The method of claim 10, wherein the programmable logic device includes a field-programmable gate array (FPGA) or a complex programmable logic device (CPLD).

12. The method of claim 10, further comprising:
detecting removal of the first input/output device from the interconnect;
detecting insertion of a second input/output device to the interconnect;
retrieving the code associated with the second input/output device; and
programming the programmable logic device such that the interconnect is operable to communicate with the second input/output device.

13. The method of claim 10, further comprising:
detecting insertion of the first input/output device;
triggering an error signal if the first type of the first input/output device is not supported; and
registering the first input/output device if the first input/output device is ready.

14. The method of claim 10, further comprising decrypting the code if the code is encrypted.

15. A system comprising:
a processor;
an interconnect coupled to the processor to communicate with a plurality of input/output devices;
a programmable logic device coupled to the interconnect;
a non-volatile memory to store code to program the programmable logic device; and
a controller operable to program the programmable logic device such that the interconnect is operable in a plurality of modes associated with the plurality of input/output devices.

16. The system of claim 15, wherein the controller is operable to detect a type of an input/output device in response to insertion of the input/output device or a system event.

17. The system of claim 16, wherein the controller is operable to
retrieve the code associated with the type of the input/output device; and
program the programmable logic device such that the interconnect is operable to communicate with the input/output device.

18. The system of claim 15, wherein the first programmable logic device comprises a field-programmable gate array (FPGA) or a complex programmable logic device (CPLD).

19. The system of claim 15, wherein the interconnect is a converged I/O interconnect.

20. The system of claim 15, wherein the controller is operable to
detect insertion of a first input/output device or a system event;
decrypt the code from the non-volatile memory if the code is encrypted;
trigger an error signal if the first input/output device is not supported; and
register the first input/output device if the first input/output device is ready.
